(19) United States
(12) Patent Application Publication
(10) Pub. No.: US 2008/0115016 A1
(43) Pub. Date: May 15, 2008

(54) SYSTEM AND METHOD FOR ANALYZING UNKNOWN FILE FORMAT TO PERFORM SOFTWARE SECURITY TEST

(75) Inventors: Young Han CHOI, Taejon (KR); Hyoung Chun Kim, Taejon (KR); Soon Jwa Hong, Taejon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Taejon (KR)

(21) Appl. No.: 11/850,921

(22) Filed: Sep. 6, 2007

(30) Foreign Application Priority Data
Nov. 13, 2006 (KR) 10-2006-0111857
May 11, 2007 (KR) 10-2007-0045914

(51) Int. Cl. G06F 11/36

(52) U.S. Cl. 714/701; 714/E11.208

(57) ABSTRACT

A system and method for analyzing a file format to perform a software security test are provided. The system includes a file scanner for monitoring a program that loads an unknown file on a memory and parsing function parameters of the loaded file, and a file analyzer for receiving the parsing data from the file scanner and extracting a field location and a data type of the unknown file format.

### BACKGROUND OF THE INVENTION

1. Field of the Invention

The present invention relates to a system and method for analyzing an unknown file format to perform a software security test, and more particularly, to a system and method for analyzing an unknown file format to perform a software security test, which can improve a code coverage by extracting a field location for an unknown file format when a fault injection scheme is used during software testing.

2. Description of the Related Art

A code coverage is a measure used in software testing. It describes the degree to which the compiled code of a program-n has been tested.

Due to rapid development of information technology (IT) field, software technology has been abruptly developed. Software is a major factor in a computer field and a communication field. Since the reliability of software is directly related to the reliability of operating systems, it is required to manage the quality of software. As the representative example of the software quality management, a software testing scheme has been widely used.

Recently, it has been required for software to have high reliability. In order to satisfy such a requirement, a time and a cost for testing software have increased. In order to reduce the software testing time and cost, a system and method for automatically testing software have been introduced. For example, a test script, test data, and a test driver are automatically generated based on source code analysis result to improve convenience in an initial process for testing software. As described above, software testing has been automatically performed from test case generation to test analysis in general.

Since a fault insertion scheme using a file, one of representative software testing schemes, arbitrarily inserts fault regardless of a file format, an error processing mechanism of a system often treats it as an error. Practically, the fault insertion scheme has a problem of a low rate of inducing the fault of target software. Also, the fault insertion scheme needs long time to considerate a file format although a file format is opened.

### SUMMARY OF THE INVENTION

Accordingly, the present invention is directed to a system and method for analyzing an unknown file format to perform a software security test, which substantially obviates one or more problems due to limitations and disadvantages of the related art.

It is an object of the present invention to provide a system and method for analyzing an unknown file format to perform a software security test, which can reduce error handling processes caused by format mismatch through extracting a data type and a field location of an unknown file format and changing a value for fault computation in order to improve a code coverage of an unknown file format among software fault detection using files.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a system for analyzing a file format to perform a software security test, including: a file scanner for monitoring a program that loads an unknown file on a memory and parsing function parameters of the loaded file; and a file analyzer for receiving the parsing data from the file scanner and extracting a field position and a data type of the unknown file format.

The file scanner may be a debugger that traces a function when an unknown file is loaded on a memory, and the file analyzer compares the function parameter with the loaded file to extracts a field position and a data type of a file format

In another aspect of the present invention, there is provided a method for analyzing a file format to perform a software security test, including the steps of: a) at a file scanner, monitoring operation of a corresponding program that loads an unknown file on a memory; b) parsing function parameters of the loaded file; c) extracting a field location and a data type of an unknown file format based on the parsing data received from a file analyzer; and d) changing a value for a fault computation in consideration of the extracted field location and data type.

In the step b), data may be extracted after classified into a number type and a string type according to use in a stack and the extracted data is parsed according to a file format.

The step c) may include the steps of: c-1) inspecting parameters when a function is called; c-2) performing an analysis process based on predetermined cases corresponding to the number of parameters of the function; and c-3) storing the analysis result.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a diagram illustrating a system for automatically analyzing a field location and a data type of an unknown file format according to an embodiment of the present invention;

FIG. 2 is diagram illustrating a stack structure for classifying data transferred as function parameters into three types; and

FIG. 3 is a flowchart illustrating a method of extracting data fields of files through function parameters.

### DETAILED DESCRIPTION OF THE INVENTION

Reference will now be made in detail to the preferred embodiments of the present invention, examples of which are illustrated in the accompanying drawings.

hereinafter, a system and method for analyzing an unknown file format to perform a software security test according to an embodiment of the present invention will be described with reference to the accompanying drawings.

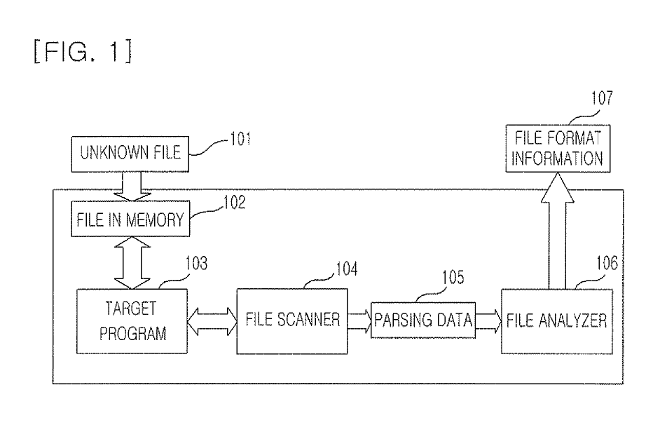

FIG. 1 is a diagram illustrating a system for automatically analyzing a field location and a data type for an unknown file format according to an embodiment of the present invention.

The system according to the present embodiment includes a file scanner 104 and a file analyzer 106.

The file scanner 104 is a module for monitoring the operation of a program that tries to load an unknown file format. The file analyzer 106 is a module for analyzing a field location and a data type of the unknown file format using the monitoring information from the file scanner 104. That is, the file scanner is a debugger that can trace a function when a target file is loaded on a memory. Also, the file analyzer extracts a field location and a data type of an unknown file format by analyzing the extracted data from.

As described above, the system according to the present invention detects and analyzes a field location and a data type for an unknown file formation through the file scanner 104 and the file analyzer 106.

Hereinafter, the operation of a system for analyzing an unknown file format to perform a software security test according to an embodiment of the present invention will be described.

As shown in FIG. 1, when a file 101 composed of unknown file formats is loaded on a memory, a target program 103 uses data of a file 102 by calling various functions. The file scanner 104 debugs a program that is loading a file. The file scanner 104 monitors the parameters of the called functions while the target file is loaded and transfers parsing data 105 to the file analyzer 106 as the related information. The file analyzer 106 outputs a field location and a data type of an unknown file format using the received information from the file scanner 104.

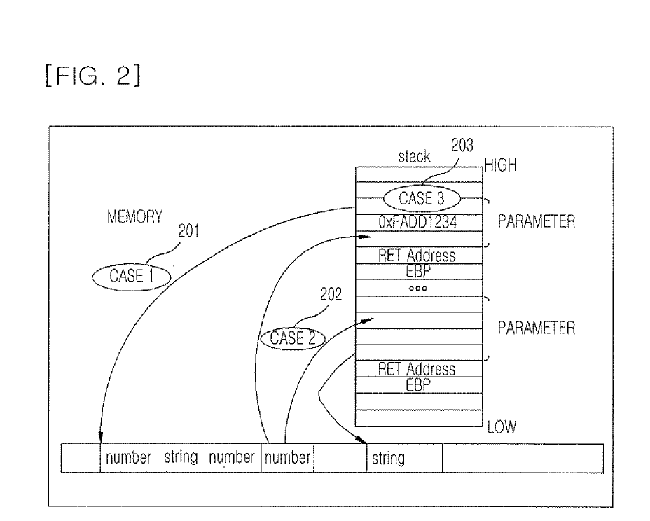

FIG. 2 is a stack structure for classifying data transferred as a function parameter into three types.

After data of a file is loaded on a memory as shown in FIG. 2, file data stored in a stack is used to parse the loaded data according to a file format.

Herein, data types to extract are classified as follows.

Number: A number data type uses two bytes or four bytes. The number data type is explicitly used as a number in software.

String: Other data types except the number data type are treated as a string data type. Although a character string may not a string data type, long data string is also treated as the string data type.

In case of classifying the data type into two types, function parameter values can be defined in three cases as follows.

Address 201 pointing a predetermined data string of a file loaded on a memory (Case 1): data string pointed by the address 201 may be a character string or a data structure. Since a file format is unknown, it is impossible to know what these values represent. Therefore, it is required to constantly monitor how the pointed data is parsed in later. If the pointed data string is a character string, a character string related function generally uses a corresponding address value as it is. In this case, the corresponding data string is treated as a character string. If the pointed data string is a data structure, the data string may be decomposed into a plurality of numbers and addresses pointing predetermined data by later function call. Since it is difficult to know whether the pointed data string is a character string or a data structure, it is required to constantly monitor the corresponding value to analyze how it is used.

Number 202 (Case 2): values of two bytes or four bytes among file data are directly used as a number. These values are explicitly used as a number in general. For these values, a position in a file and the number of used bytes are analyzed, and a fault computation related to the number is performed when a fault insertion is performed later. Although a corresponding value can be used as an offset that denotes a position in a file, these values are explicitly used as a number.

Data 203 generated in software (Case 3): corresponding parameter values are values internally generated when software loads a file. Although these corresponding parameter values may be used as a number or an address pointing a predetermined data, it is not necessary to detect a field location in a file. Therefore, it is ignored to analyze a field location of an unknown file format in the present embodiment.

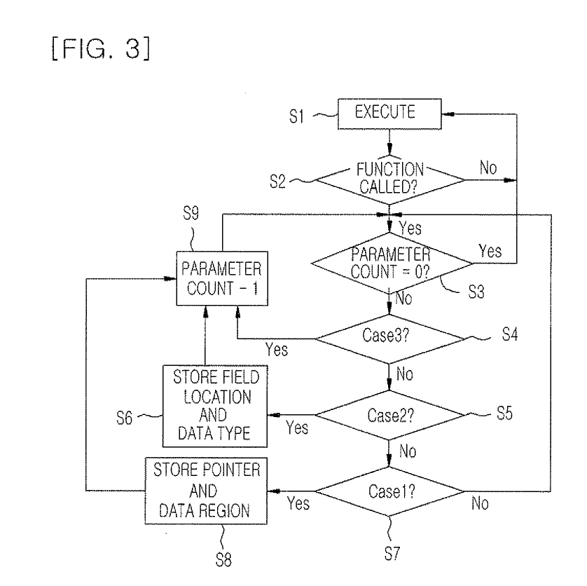

FIG. 3 is a flowchart illustrating a method of extracting data fields of files through a function parameter.

Referring to FIG. 3, a method of extracting a field location and a data type based on three cases of FIG. 2 at the file analyzer 106 will be described.

In case of loading a normal file in response to an execution instruction at step S1, a parameter is inspected when a function is called at step S2.

A parameter count denotes the number of parameters of a corresponding function at step S3, and parameters are inspected whether these parameters are included in Case 1, Case 2, and Case 3 as many as the number of parameters.

If a corresponding parameter is included in the Case 3 at step S4, the corresponding value is ignored because it is not used to detect a field location in file data.

If a corresponding parameter is included in the Case 2 at step S5, a field location having a corresponding parameter value and a length thereof for example, 2-bytes or 4-bytes, are stored at step S6. Since the field location is detected in the file data, the field location is not traced any more.

In case of the Case 1 at step S7, it is difficult to know whether pointed data string is a character string or data structure. After a related function is called later, it is possible to know what the data string is parsed to. Therefore, a location and a range of data region stored in a memory and a pointer pointing to the data region are stored for monitor the pointed data string later at step S8. These values are used to extract data type when a related function is called later.

These steps S3 to S8 are repeatedly performed according to the number of parameters.

The system and method for analyzing an unknown file format to perform a software security test according to the present embodiment can reduce error handling processes performed by format mismatch while software is testing according to a standard of a predetermined file format. Therefore, faults of software can be effectively induced as many as possible using limited number of fault inducing files. Also, the system and method according to the present embodiment can improve a code coverage by extracting a data type and a field location of an unknown file format when the fault insertion scheme is used.

It will be apparent to those skilled in the art that various modifications and variations can be made in the present invention. Thus, it is intended that the present invention covers the modifications and variations of this invention provided they come within the scope of the appended claims and their equivalents.

1. A system for analyzing a file format to perform a software security test, comprising:
a file scanner for monitoring a program that loads an unknown file on a memory and parsing function parameters of the loaded file; and
a file analyzer for receiving the parsing data from the file scanner and extracting a field location and a data type of the unknown file format.

2. The system of claim 1, wherein the file scanner is a debugger that traces a function when an unknown file is loaded on a memory.

3. The system of claim 1, wherein the file analyzer compares the function parameter with the loaded file to extracts a field location and a data type of a file format.

4. A method for analyzing a file format to perform a software security test, comprising the steps of:
a) at a file scanner, monitoring operation of a corresponding program that loads an unknown file on a memory;
b) parsing function parameters of the loaded file;
c) extracting a field location and a data type of an unknown file format based on the parsing data received from a file analyzer; and
d) changing a value for a fault computation in consideration of the extracted field location and data type.

5. The method of claim 4, wherein in the step b), data is extracted after classified into a number type and a string type according to use in a stack and the extracted data is parsed according to a file format.

6. The method of claim 5, wherein a function parameter value corresponding to the number type and the string type is defined as one of an address pointing a predetermined data of a file, a number, and data generated by software.

7. The method of claim 6, wherein if the function parameter value is an address pointing a predetermined data of a file loaded on a memory, the function parameter value is used as one of a character string in which a corresponding address value is used in a function related to the character string and a data structure that is decomposed into a plurality of numbers and an address pointing a predetermined data in a later function call.

8. The method of claim 6, wherein if the function parameter value is the number, a position in a file and the number of bytes are detected and a fault related to the number is calculated when fault insertion is performed later.

9. The method of claim 6, wherein if the function parameter value is data generated by software, the function parameter value is used as an address pointing predetermined data.

10. The method of claim 5, wherein the step c) includes the steps of:
c-1) inspecting parameters when a function is called;
c-2) performing an analysis process based on predetermined cases corresponding to the number of parameters of the function; and
c-3) storing the analysis result.

11. The method of claim 10, wherein if the case is an address pointing a predetermined data of a file loaded on a memory, a location and a range of a data region stored in a memory and a pointer pointing the data region are stored for monitoring data later.

12. The method of claim 11, wherein the stored location and range of the data region stored in the memory and the pointer pointing the data region are used to extract a data type when a function is called later.

13. The method of claim 10, wherein if the case is a number, a field location of a file including a corresponding parameter value and a data type are stored.

14. The method of claim 10, wherein if the case is data generated by a program, the generated data value is ignored.

15. The method of claim 9, wherein the step c) includes the steps of:
c-1) inspecting parameters when a function is called;
c-2) performing an analysis process based on predetermined cases corresponding to the number of parameters of the function; and
c-3) storing the analysis result.

16. The method of claim 8, wherein the step c) includes the steps of:
c-1) inspecting parameters when a function is called;
c-2) performing an analysis process based on predetermined cases corresponding to the number of parameters of the function; and
c-3) storing the analysis result.

17. The method of claim 7, wherein the step c) includes the steps of:
c-1) inspecting parameters when a function is called;
c-2) performing an analysis process based on predetermined cases corresponding to the number of parameters of the function; and
c-3) storing the analysis result.

18. The method of claim 6, wherein the step c) includes the steps of:
c-1) inspecting parameters when a function is called;
c-2) performing an analysis process based on predetermined cases corresponding to the number of parameters of the function; and
c-3) storing the analysis result.
